(19) United States
(12) Patent Application Publication
(10) Pub. No.: US 2013/0219324 A1
(43) Pub. Date: Aug. 22, 2013

(54) REMOTE CONTROL METHOD AND APPARATUS FOR A MOBILE TERMINAL

(71) Applicant: RSUPPORT Co., Ltd., (US)

(72) Inventors: Hyung Su SEO, Yangpyeong-gun (KR); Myoung Seop KIM, Seongnam-si (KR)

(73) Assignee: RSUPPORT Co., Ltd., Seoul (KR)

(21) Appl. No.: 13/758,516

(22) Filed: Feb. 4, 2013

(30) Foreign Application Priority Data
Feb. 22, 2012 (KR) 10-2012-0017764

(51) Int. Cl. G06F 3/0484

(52) U.S. Cl. CPC G06F 3/0484
USPC 715/780

(57) ABSTRACT

A method of remotely controlling a mobile terminal is disclosed. According to an aspect, there is provided a method in which a computer connected to a mobile terminal remotely controls the mobile terminal, including: displaying a remote control window which is a user interface for receiving data for controlling the mobile terminal, on a screen of the computer; sensing an input of text data through manipulation of an input unit of the computer, and displaying the text data on a predetermined area of the remote control window; and transmitting the text data displayed on the predetermined area of the remote control window to the mobile terminal if a predetermined value is input through the input unit of the computer.

### CLAIM FOR PRIORITY

This application claims priority to Korean Patent Application No. 10-2012-0017764 filed on Feb. 22, 2012 in the Korean Intellectual Property Office (KIPO), the entire contents of which are hereby incorporated by reference.

### BACKGROUND

1. Technical Field

An example embodiment of the present invention relates in general to a remote control method and apparatus for a mobile terminal, and more specifically, to a remote control method and apparatus for allowing a computer to remotely control a mobile terminal connected through a network.

2. Related Art

Personal Computer (PC) remote control is technology for remotely accessing and controlling PCs that are a great distance away or distributed over a large area. PC remote control enables a user to remotely use his or her PC through the Internet, that is, to remotely use all functions of his or her PC while viewing the screen of another computer connected to the Internet.

Due to its convenience, PC remote control which has been used to monitor and manage user PCs at enterprise, has been widely propagated to home users. Accordingly, many home users control their PCs using a remote control tool at an office or at home.

Meanwhile, with the generalized use of the Internet through a mobile terminal such as a smart phone, applications for remotely controlling a smart phone through a PC are being developed. However, in order to remotely control a smart phone with a touch screen using a PC, a virtual keypad should be used, unlike a PC-to-PC remote control solution. However, it is inconvenient to input text requiring complicated manipulation through a virtual keypad.

### SUMMARY

Accordingly, example embodiments of the present invention are provided to substantially obviate one or more problems due to limitations and disadvantages of the related art.

An example embodiment of the present invention provides a remote control method of a mobile terminal, allowing a user to conveniently input text requiring complicated manipulation.

Another example embodiment of the present invention also provides a remote control apparatus of a mobile terminal, allowing a user to conveniently input text requiring complicated manipulation.

In an example embodiment, there is provided a method in which a computer wired or wirelessly connected to a mobile terminal remotely controls the mobile terminal, including: displaying a remote control window which is a user interface for receiving data for controlling the mobile terminal, on a screen of the computer; sensing an input of text data through manipulation of an input unit of the computer, and displaying the text data on a predetermined area of the remote control window; and transmitting the text data displayed on the predetermined area of the remote control window to the mobile terminal if a predetermined value is input through the input unit of the computer.

In another example embodiment, there is provided a method in which a mobile terminal is remotely controlled by data received from a computer wired or wirelessly connected to the mobile terminal, including: determining whether the received data is text data; and displaying the received data in a text input control on an active window of the mobile terminal if it is determined that the received data is text data.

Therefore, according to the method and apparatus for remotely controlling the mobile terminal, as described above, by providing a user interface allowing a user to input text data using an input unit such as the keyboard of a computer, as well as a virtual keypad, the user's convenience can be improved.

In detail, by displaying a text box for representing data input through the keyboard of the computer on a remote control window, and transmitting input text to a mobile terminal that is to be controlled at a specific time, it is possible to provide a more convenient user interface while having the same effect of transmitting values input through a virtual keypad to a mobile terminal. Particularly, inputting text through the keyboard may be useful when a user inputs 2-byte (Unicode) data, such as special characters, Korean, Japanese, Chinese, etc., requiring complicated manipulations.

Also, in the case of inputting text using a virtual keypad, data transfer occurs whenever mouse manipulation is generated, however, in the case of inputting text through keyboard manipulations, a user can transmit data or cancel data transfer after inputting all desired data, which contributes to an increase of transmission efficiency.

### BRIEF DESCRIPTION OF DRAWINGS

Example embodiments of the present invention will become more apparent by describing in detail example embodiments of the present invention with reference to the accompanying drawings, in which:

FIG. 1 is a conceptual view showing a conceptual configuration of a remote control system for a mobile terminal, according to an embodiment of the present invention;

FIG. 2 is a flowchart illustrating a method in which a computer remotely controls a mobile terminal, according to an embodiment of the present invention;

FIG. 3 is a block diagram showing the relationship between components in a remote control apparatus for a mobile terminal, according to an embodiment of the present invention; and

FIG. 4 is a flowchart illustrating a method in which a mobile terminal is remotely controlled, according to an embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, embodiments of the present invention will be described in detail with reference to the appended drawings. In the following description, for easy understanding, like numbers refer to like elements throughout the description of the figures, and the same elements will not be described further.

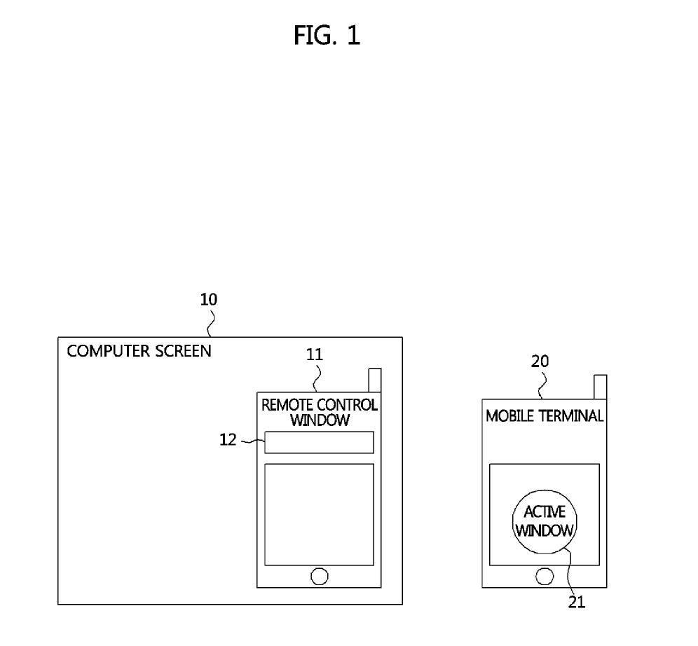

FIG. 1 is a conceptual view showing a conceptual configuration of a remote control system for a mobile terminal 20, according to an embodiment of the present invention;

Referring to FIG. 1, the remote control system for the mobile terminal 20 may be configured to include a remote control apparatus installed in a computer to control the mobile terminal 20. Also, the remote control apparatus may be configured to provide a remote control window 11 which is a user interface, to remotely control the mobile terminal 20, on the screen of the computer, and to transmit values input through the remote control window 11 to the mobile terminal 20.

The mobile terminal 20 may be a portable phone such as a smart phone.

Meanwhile, the remote control window 11 may include a text data field 12 for representing text values input through the input unit (for example, a keyboard) of the computer. For example, if a text value is input through a keyboard when the remote control window 11 is activated, that is, when the remote control window 11 is an active window, the text value may be represented on the text data field 12.

Or, text input through a copy or move (using the right button of a mouse or the Control (Ctrl) key of a keyboard) of a text value using the clipboard, may also be represented on the text data field 12.

The text value represented on the text data field 12 may be transmitted to the mobile terminal 20 when a specific key or the mouse is manipulated, for example, when a predetermined value is input (e.g., when the Enter key is pressed).

As such, inputting text through the keyboard may provide a more convenient user interface while having the same effect of displaying a virtual keypad on the remote control window 11 of the computer screen 10 to control the screen of the mobile terminal 20, and transmitting values input through the mouse, etc. to the mobile terminal 20. Particularly, inputting text through the keyboard may be useful when a user inputs 2-byte (Unicode) data, such as special characters, Korean, Japanese, Chinese, etc., requiring complicated manipulations.

Also, in the case of inputting text using a virtual keypad, data transfer occurs whenever a mouse manipulation is generated, however, in the case of inputting text through keyboard manipulation, a user can transmit data or cancel data transfer after inputting all desired data, which contributes to an increase of transmission efficiency.

Inputting text through manipulations of the keyboard eliminates a need of providing a virtual keypad on the remote control window 11. However, it is also possible to provide a virtual keypad together according to a user's needs. Values input to the remote control window 11 are independent from the kind or state of the input unit of the mobile terminal 20.

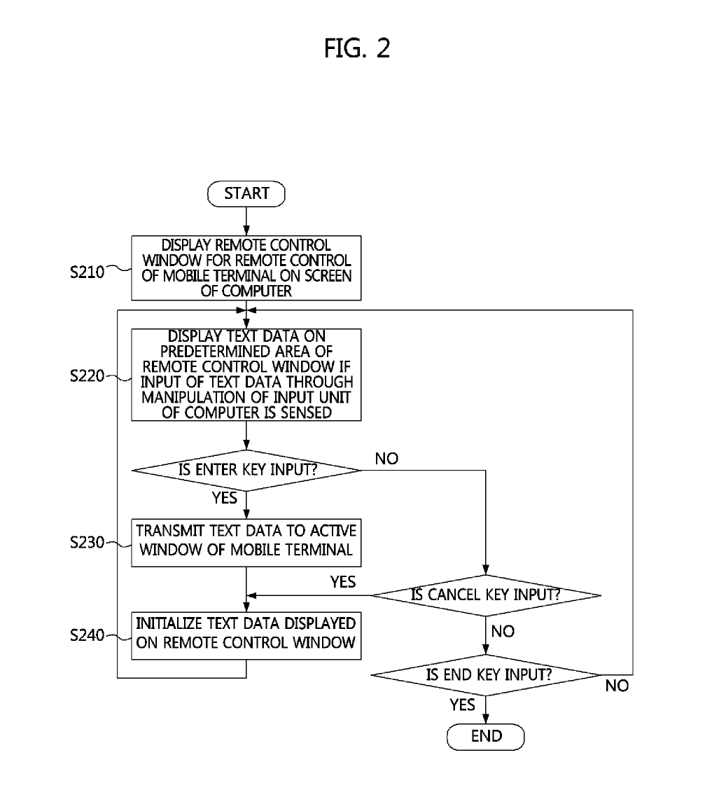

FIG. 2 is a flowchart illustrating a method of remotely controlling a mobile terminal, according to an embodiment of the present invention.

Referring to FIG. 2, the method, which is performed by a computer connected to the mobile terminal through a network, includes operation S210 of displaying a remote control window, operation S220 of sensing and displaying text data, operation S230 of transmitting the text data, and operation S240 of initializing the text data.

The method of remotely controlling the mobile terminal will be described in detail with reference to FIG. 2, below.

In operation S210 of displaying the remote control window, the remote control window which is a user interface to remotely control the mobile terminal, may be displayed on the screen of the computer. That is, for example, the mobile terminal may be controlled by receiving data or a command input through the remote control window.

For example, inputting data through the remote control window may have the same effect of inputting the data to an active window of the mobile terminal that is to be remotely controlled.

At this time, by displaying a virtual keypad on the remote control window or allowing data to be input through the keyboard of the computer, the same effect as if data is directly input to the mobile terminal may be provided.

In operation S220 of sensing and displaying text data, if an input of text data through manipulation of the input unit of the computer is sensed, the text data may be displayed on a predetermined area of the remote control window.

For example, if an input of text through the keyboard or mouse of the computer is sensed while the remote control window displayed on the screen of the computer is activated, the text may be displayed on a predetermined area of the remote control window.

Also, if keyboard manipulation (for example, Ctrl C/Ctrl V) for fetching data stored in the clipboard other than text data corresponding to keys on the keyboard of the computer, or clicking on the right button of the mouse is sensed, the data stored in the clipboard may be displayed on a predetermined area of the remote control window.

The method of inputting text data through the input unit of the computer provides a more convenient user interface than the method of inputting text data through the virtual keypad, as described above with reference to FIG. 1. Specifically, data such as special characters requiring complicated multi-stage manipulations can be easily input through the keyboard.

In operation S230 of transmitting the text data, if a predetermined value is input through the input unit of the computer, the text data displayed on the predetermined area of the remote control window may be transmitted to the mobile terminal or to the active window of the mobile terminal.

For example, if the Enter key is pressed, the text data displayed on the predetermined area of the remote control window may be transmitted to the mobile terminal. Also, after the text data is transmitted to the mobile terminal, the predetermined area of the remote control window may be initialized.

In operation S240 of initializing the text data, if a predetermined value (for example, a value corresponding to the Esc key) is input through the input unit of the computer, the text data displayed on the predetermined area of the remote control window may be initialized, for example, the predetermined area may become a blank area. That is, when a user wants to cancel input text data without transferring it to the mobile terminal, he or she may input a predetermined value to erase the text data displayed on the remote control window, without transferring the text data to the mobile terminal.

This operation is possible since no input text is transferred to the mobile terminal although the text is shown on the remote control window, as long as there is no key manipulation (for example, pressing the Enter key or a predetermined function key after inputting a text value) for confirming transfer.

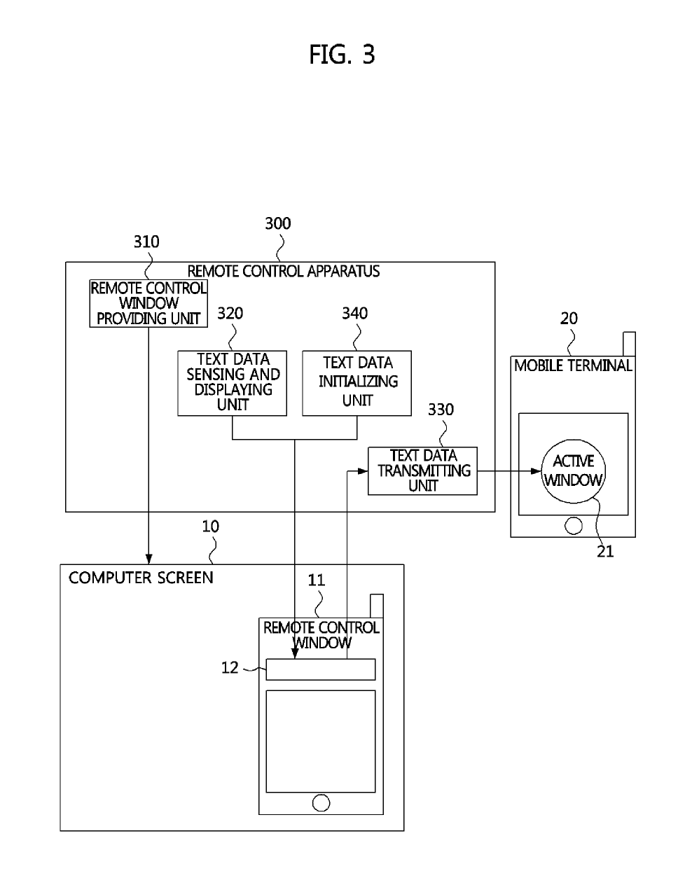

FIG. 3 is a block diagram showing the relationship between components included in a remote control apparatus for a mobile terminal, according to an embodiment of the present invention.

Referring to FIG. 3, the remote control apparatus for the mobile terminal, which is a remote control apparatus 300 for controlling the mobile terminal on a computer connected to the mobile terminal through a network, may be configured to include a remote control window providing unit 310, a text data sensing and displaying unit 320, a text data transferring unit 330, and a text data initializing unit 340.

The components included in the remote control apparatus 300 for the mobile terminal, and the relationship between the components will be described in detail with reference to FIG. 3, below.

The remote control window providing unit 310 provides a remote control window 11 which is a user interface for receiving data for controlling the mobile terminal 20 on the screen 10 of a computer.

The text data sensing and displaying unit 320 senses an input of text data through manipulation of the input unit (not shown) of the computer, and displays the input text data on a text data field 12 of the remote control window 11.

At this time, the text data sensing and displaying unit 320 may sense an input of text data through manipulation of the input unit (for example, a keyboard or a mouse) of the computer when the remote control window 11 is an active window.

Also, the text data sensing and displaying unit 320 may sense manipulation of the keyboard or mouse of the computer for fetching data stored in the clipboard of the computer (for example, by fetching data on the clipboard using the right button of the mouse or the Control (Ctrl) key of the keyboard), and display the data of the corresponding clipboard on the text data field 12 of the remote control window 11.

The text data transferring unit 330 may transfer, if a predetermined value is input through the input unit of the computer, the text data displayed on the text data field 12 of the remote control window 11 to the mobile terminal 20.

At this time, the text data transferring unit 330 may transmit the text data displayed on the text data field 12 to the active window 21 of the mobile terminal 20, and initialize the text data field 12 after the transmission of the text data.

The text data initializing unit 340 may initialize the text data field 12 if a predetermined value is input through the input unit of the computer. For example, if a user wants to cancel a value displayed on the text data field 12 without transmitting the value to the mobile terminal 20, the user may press a predetermined function key or a predetermined short key of the keyboard of the computer to erase the data of the text data field 12, thereby preventing unnecessary data from being transmitted.

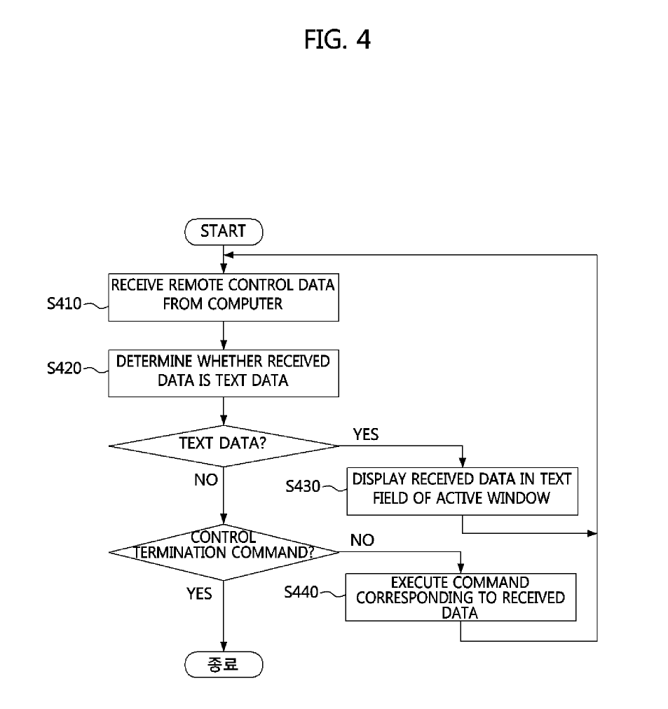

FIG. 4 is a flowchart illustrating a method in which a mobile terminal is remotely controlled, according to an embodiment of the present invention.

Referring to FIG. 4, the method in which the mobile terminal is remotely controlled may include operation S410 of receiving remote control data, operation S420 of determining whether the received data is text data, operation S430 of displaying the text data, and operation S440 of executing a command. Also, operations S410 through S440 may be performed in a mobile terminal that is controlled by a computer connected through a network.

The method in which the mobile terminal is remotely controlled, according to the embodiment of the present invention, will be described in detail with reference to FIG. 4, below.

In operation 410 of receiving the remote control data, a command, etc. for controlling the mobile terminal may be received from the computer that controls the mobile terminal. Accordingly, a predetermined program may be installed in the mobile terminal by the computer, and may be driven in the mobile terminal so that the mobile terminal can be controlled by the computer.

Accordingly, if the mobile terminal receives data input through a remote control window of the computer, the mobile terminal may determine the data as a command for remote control.

In operation S420 of determining whether the received data is text data, it may be determined whether the remote control data received from the computer is text data. For example, if the received data is a string, not coordinate values of a virtual keypad, the mobile terminal may determine the received data as text data. Or, if the received data includes a predetermined value, the mobile terminal may determine the received data as text data.

For example, if text input through manipulation of the keyboard or mouse of the computer, instead of values input by manipulating the keypad displayed on the remote control window of the computer with a mouse, has been displayed on the remote control window, and the displayed text has been at once transmitted to the mobile terminal, as described above, the mobile terminal may determine the received data as text data. Also, in this case, when the computer transmits the text data, the computer may include a predetermined value in the text data in order to inform that the corresponding data is text data.

In operation S430 of displaying the text data, if it is determined in operation S420 that the received data is text data, the received data may be displayed in a text input control on the active window of the mobile terminal.

The text input control on the active window may be a user interface that is provided on the active window in order to display or edit text that is input through manipulation of the mobile terminal.

In operation S440 of executing the command, if it is determined in operation S420 that the received data is not text data, a predetermined control command corresponding to the received data may be executed.

While the example embodiments of the present invention and their advantages have been described in detail, it should be understood that various changes, substitutions and alterations may be made herein without departing from the scope of the invention.

1. A method in which a computer wired or wirelessly connected to a mobile terminal remotely controls the mobile terminal, comprising:
displaying a remote control window which is a user interface for receiving data for controlling the mobile terminal, on a screen of the computer;
sensing an input of text data through manipulation of an input unit of the computer, and displaying the text data on a predetermined area of the remote control window; and
transmitting the text data displayed on the predetermined area of the remote control window to the mobile terminal if a predetermined value is input through the input unit of the computer.

2. The method of claim 1, wherein the sensing and displaying of the text data comprises sensing an input of text data through manipulation of a keyboard or a mouse of the computer when the remote control window is an active window.

3. The method of claim 1, wherein the sensing and displaying of the text data comprises displaying data stored in a clipboard of the computer on the predetermined area of the remote control window if manipulation of a keyboard or a mouse of the computer for fetching the date stored in the clipboard is sensed.

4. The method of claim 1, wherein the text data displayed on the predetermined area of the remote control window is transmitted to the active window of the mobile terminal.

5. The method of claim 1, wherein the transmitting of the text data displayed on the predetermined area of the remote control window to the mobile terminal comprises initializing the predetermined area of the remote control window after transmitting the text data displayed on the predetermined area of the remote control window to the mobile terminal.

6. The method of claim 1, further comprising initializing the predetermined area of the remote control window if a predetermined value is input through the input unit of the computer.

7. A method in which a mobile terminal is remotely controlled by data received from a computer wired or wirelessly connected to the mobile terminal, comprising:
determining whether the received data is text data; and
displaying the received data in a text input control on an active window of the mobile terminal if it is determined that the received data is text data.

8. The method of claim 7, wherein the determining of whether the received data is text data comprises determining that the received data is text data if the received data includes a predetermined value.

9. The method of claim 7, wherein the text input control on the active window is a user interface that is provided on the active window in order to display or edit text that is input through manipulation of the mobile terminal.

10. The method of claim 7, further comprising determining whether the received data relates to a remote control command for the mobile terminal, wherein if it is determined that the received data relates to a remote control command for the mobile terminal, it is determined whether the received data is text data, and the received data is displayed in the text input control.

11. A remote control system comprising:
a remote control apparatus configured to remotely control a mobile terminal through a remote control window displayed on a screen of a computer, to sense an input of text data through manipulation of an input unit of the computer, to display the text data on a predetermined area of the remote control window, and to transmit the text data displayed on the predetermined area of the remote control window to the mobile terminal if a predetermined value is input through the input unit of the computer; and
a mobile terminal configured to be remotely controlled by data received from the computer, and to display, if the received data is text data, the received text data in a text input control on an active window.

12. The remote control system of claim 11, wherein if the remote control apparatus senses an input of text data through manipulation of a keyboard or a mouse of the computer, or senses manipulation of the keyboard or the mouse of the computer for fetching data stored in a clipboard of the computer when the remote control window is an active window, the remote control apparatus displays the data stored in the clipboard on a predetermined area of the remote control window.

13. The remote control system of claim 11, wherein the mobile terminal determines that the received data is text data if the received data includes a predetermined value.

14. The method of claim 2, wherein the sensing and displaying of the text data comprises displaying data stored in a clipboard of the computer on the predetermined area of the remote control window if manipulation of a keyboard or a mouse of the computer for fetching the date stored in the clipboard is sensed.

15. The method of claim 4, wherein the transmitting of the text data displayed on the predetermined area of the remote control window to the mobile terminal comprises initializing the predetermined area of the remote control window after transmitting the text data displayed on the predetermined area of the remote control window to the mobile terminal.
